(19) United States
(12) Patent Application Publication
(10) Pub. No.: US 2022/0227251 A1
(43) Pub. Date: Jul. 21, 2022

(54) A METHOD AND SYSTEM FOR CHARGING ELECTRIC VEHICLES (EVS) USING BLOCK CHAIN

(71) Applicant: ABB Schweiz AG, Baden (CH)

(72) Inventors: Ravishankar Y. A., Bangalore (IN); Sukumara T., Bangalore (IN)

(21) Appl. No.: 17/615,445

(22) PCT Filed: May 31, 2020
(86) PCT No.: PCT/IB2020/055152

§ 371 Date: Nov. 30, 2021

(30) Foreign Application Priority Data
May 31, 2019 (IN) 20194102803

(51) Int. Cl. B60L 53/66; B60L 53/30; B60L 53/64; B60L 53/65; H04L 9/00

(52) U.S. Cl. CPC B60L 53/665; B60L 53/305; H04L 2209/84; B60L 53/65; H04L 9/50; B60L 53/64

(57) ABSTRACT

The present invention relates to a method and a system for charging Electric Vehicles (EV) (101) at charging points associated with a first or a second energy distribution vendor (104). A charging point (103) connected to an electric vehicle system operator (EVSO) (105) receives information related to the EV (101) and an energy transaction for charging the EV (101). The EVSO (105) verifies the identity of the EV and charging point (101) and authorizes the charging point (103) to charge the EV (101) based on the energy transaction. The EVSO (105) determines the one or more sister block chain (401, 402 and 403) associated with the first or the second distribution vendor for storing the energy transaction. The EVSO (105) stores all the energy transactions associated with plurality of energy distribution vendors (104) in a mother block chain (404). Upon receiving the authorization, the charging point (103) charges, the EV (101).

### TECHNICAL FIELD

The current invention relates in general to electric vehicle chargers and more particularly to electric vehicle chargers for charging electric vehicles using a block chain.

### BACKGROUND

In recent past, there is increase in the trend to use Electric Vehicle (EV). The EV is driven by the electric motors. The energy for the electric motors is supplied via the rechargeable batteries associated with the EV. In this type of electrically driven vehicle, the rechargeable batteries must be charged when the voltage of the rechargeable batteries decreases. The electric energy needed to charge the EV can be supplied over long distances from the electric grid and distributed to plurality of energy distribution vendors for charging the rechargeable batteries associated with the EV.

An issue with the existing techniques is the lack of authentication scheme for the EV to allow guest charging using a smart sub metering mechanism at home or commercial complex. Further, an EV with single authentication key may not be able to charge the rechargeable batteries associated with the EV from multiple energy distribution vendors, home or commercial complex.

Another issue with the existing techniques is the centralized EV energy transaction repository does not allow plurality of energy distribution vendors to store and verify the energy transaction using the centralized EV energy transaction repository.

In view of the above, there is a need to address at least one of the abovementioned limitations and propose a method and system to overcome the abovementioned problems.

### SUMMARY OF THE INVENTION

In an embodiment the present invention relates to a method for charging an Electric Vehicle (EV) from a charging point of an EV charger. In an embodiment, identification information of the EV is stored in a vendor information unit associated with a first energy distribution vendor or a second energy distribution vendor among plurality of energy distribution vendors and with an electric vehicle system information unit (112) associated with an electric vehicle system operator (EVSO). The charging point of the EV charger is communicably connected to the electrical vehicle system information unit. Identification information of the charging point of the EV charger is stored in the vendor information unit associated with the first energy distribution vendor, and identification information of the plurality of energy distribution vendors are stored in the electric vehicle system information unit (112), and a plurality of information relating to energy transactions performed by the plurality of energy distribution vendors is stored in a mother block chain associated with the electric vehicle system information unit (112) of the EVSO. In an embodiment, the charging point receives identification information of the EV from the EV and energy transaction for the EV. Further, the charging point transmits the received identification information from the EV and identification information of the charging point to the electrical vehicle system information unit. The electrical vehicle system information unit verifies identity of electric vehicle and identity of charging point and determines one or more sister block chains associated with one or more energy distribution vendors from the plurality of energy distribution vendors for storing the energy transaction information and for storing the energy transaction information in the mother block chain. In an embodiment, the EV is registered with the first energy distribution vendor or with the second energy distribution vendor. The charging point receives the result of determination of EV being registered with the first energy distribution vendor or with the second energy distribution vendor. Thereafter, the charging point provides energy transaction information to the electrical vehicle system information unit for the electrical vehicle system information unit to store the energy transaction information in one or more sister block chain associated with one or more energy distribution vendors based on determination of EV being registered with the first energy distribution vendor or with the second energy distribution vendor. Upon the determination, the charging point provides electrical charging to the EV as per the energy transaction information.

In an embodiment, the energy transaction information is stored in at least one of a sister block chain associated with the first energy distribution vendor when the charging is being performed by the first energy distribution vendor, and the sister block chain associated with the first energy distribution vendor and the second energy distribution vendor, when the charging is being performed by the second energy distribution vendor.

In an embodiment, the identification information of the EV comprises at least one of EV manufacturer information, parent distribution unit information associated with the EV, EV registration information, EV model information, and EV owner information.

In an embodiment, the energy transaction information comprises at least one of details of the EV, details of the EV charging point of the EV charger, details of the first or second energy distribution vendor, details of manufacturer of the EV, duration of charging the EV at the charging point of the EV charger, details of unit cost of energy transfer, details of total cost of charging the EV at the charging point of the EV charger.

In an embodiment, the energy transaction information is recorded according IEC 61850 protocol.

In an embodiment, current and voltage samples values of the EV charging is recorded using IEC 61850 9-2 protocol and transmitted to the first distribution unit for performing remote diagnostic check of the EV charging point.

In an embodiment, total energy consumed by the EV during charging is verified using the energy transaction information stored in the mother block chain and one or more sister block chain.

Systems of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

The subject matter of the invention will be explained in more detail in the following text with reference to preferred exemplary embodiments which are illustrated in the drawings, in which:

FIG. 1 shows an exemplary environment for charging Electric Vehicles, in accordance with an embodiment of the present disclosure;

FIG. 2 shows an exemplary flow chart for charging Electric Vehicles at a charging point of the EV charger, in accordance with an embodiment of the present disclosure;

FIG. 3 illustrates an exemplary environment to select a charging point, in accordance with an embodiment of the present disclosure;

FIG. 4 illustrates an exemplary mother and sister block chain for storing an energy transaction, in accordance with an embodiment of the present disclosure;

FIG. 5 illustrates an exemplary registration process of the EV, in accordance with an embodiment of the present disclosure;

FIG. 6 illustrates an exemplary registration process of the EV charger, in accordance with an embodiment of the present disclosure;

FIG. 7 illustrates an exemplary verification of total energy received and consumed by the data miners, in accordance with an embodiment of the present disclosure;

FIG. 8 illustrates an exemplary EV charger, in accordance with an embodiment of the present disclosure;

FIG. 9 illustrates an exemplary first EV to second EV charging, in accordance with an embodiment of the present disclosure;

FIG. 10 illustrates an exemplary docker container for storing the block chain, in accordance with an embodiment of the present disclosure. and

FIG. 11 shows an exemplary consortium of the EVSO, in accordance with an embodiment of the present disclosure.

### DETAILED DESCRIPTION

The present invention discloses a method and system for charging electric vehicles using block chain. A charging point connected to an EVSO receives information related to the EV and an energy transaction for charging the EV. The EVSO verifies the identity of the EV and authorizes the charging point to charge the EV based on the energy transaction. The EVSO determines the one or more sister block chain associated with the first or the second distribution vendor for storing the energy transaction. The EVSO stores all the energy transactions associated with plurality of energy distribution vendors in a mother block chain. Upon receiving the authorization, the charging point charges, the EV.

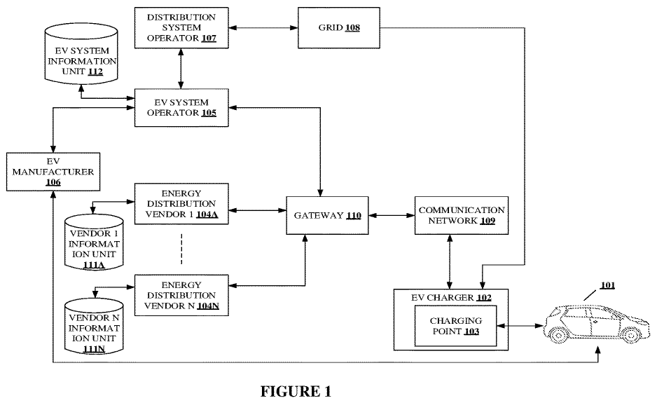

FIG. 1 shows an exemplary environment for charging electric vehicles. The Electric Vehicle (EV) (101) is a vehicle propelled by one or more electric motors, using energy stored in rechargeable batteries of the EV (101). An EV manufacturer (106) manufactures the EV (101) and a server (herein referred as EV manufacturer (106) server) hosted by the EV manufacturer (106) is communicatively connected to the EV (101). In an embodiment, the EV (101) and the EV manufacturer (106) server are connected using at least one of, a cellular network, vehicular networks and the like. The EV manufacturer (106) server calculates the energy stored in the rechargeable batteries of the EV (101) based on the information received from the EV (101). Typically, the EV manufacturer (106) server receives a plurality of information of the EV (101) for analytics and to further improve the EV (101). In one example, the EV manufacturer (106) server can receive information related to battery charging and discharging and can use this information to improve the batteries. In another example, the EV manufacturer (106) server can monitor EV battery state and can recommend nearby charging points. In an embodiment, the EV manufacturer (106) may be associated with one or more energy distribution vendors (104) for providing chargers comprising charging points to charge the EV (101). For example, an EV manufacturer (106) like XYZ can be associated with energy distribution vendors (104) like vendor 1. In one embodiment, the energy distribution vendors (104) can install chargers in a plurality of locations for the EVs of the associated EV manufacturers to charge the EVs. In one embodiment, chargers may be similar to a charging station. In a further embodiment, the chargers comprise a plurality of charging point (103). In an embodiment, the charging point (103) may be an energy vending machine configured to transfer charges to the EV (101). In an embodiment, each of plurality of energy distribution vendors (104) has a vendor information unit (111) for storing identification information of the EV (101), identification information of the charging point (103) of an EV charger (102) and energy transaction associated with charging of the EV (101). For example, when an EV (101) enters an EV charger (102) for charging, the EV (101) may be authenticated prior to charging. Likewise, the charging point (103) of the charger and an energy transaction initiated by the EV (101) are authenticated. Let us consider a first energy distribution vendor (104) among the plurality of energy distribution vendor (parent energy distribution vendor) is registered to buy power along with several energy distribution vendors who are in business of providing power. In an embodiment, a charger comprising one or more charging points is installed by a first energy distribution vendor (parent energy distribution vendor (104)). In an embodiment, a plurality of such chargers can be installed by the first energy distribution vendor.

In an embodiment, the one or more charging points are primarily configured to charge the EV (101) associated with the first energy distribution vendor (104). In one embodiment, EVs associated with other energy distribution vendors (104) can also be charged by the one or more charging points i.e. the EV can also be charged by another energy distribution vendor (second energy distribution vendor) apart from the parent energy distribution vendor (first energy distribution vendor). In one embodiment, a cost of charging the EV (101) associated with the first energy distribution vendor (104) can be less than a cost of charging the EVs associated with other energy distribution vendor (104). Each of the energy distribution vendor (104) are associated with a vendor information storage unit (a database). Each energy distribution vendor (104) can monitor respective chargers and can store information related to respective chargers, respective one or more charging points, EVs charged in the respective one or more charging points, transaction details in respective vendor information storage units. The DSO (107) can include one or more computing units operated by one or more operators. The one or more computing units along with the one or more operators together can be referred as DSO (107). The DSO (107) is configured to distribute the electric energy from a grid (108) to the plurality of chargers. In an embodiment, the grid (108) is an interconnected network of power generating stations, transmission lines, distribution lines for delivering electricity from producers to consumers. In an embodiment, amount of energy distributed to each charger from the grid (108) is recorded in an EV system information unit associated with the EVSO and information unit (112) associated with DSO. The EV system information unit (112) also store identification information of the plurality of energy distribution vendors (104). The one or more charging points of the EV charger (102) is connected to a gateway (110) via a communication network (109). The gateway (110) is used to route the information between the EVSO (105), plurality of energy distribution vendor (104) and the one or more charging points of the EV charger (102). Further description is provided with respect to one charging point (103). However, this should not be considered as a limitation and aspects associated with to a single charging point (103) can be applicable to the one or more charging points of the EV charger (102).

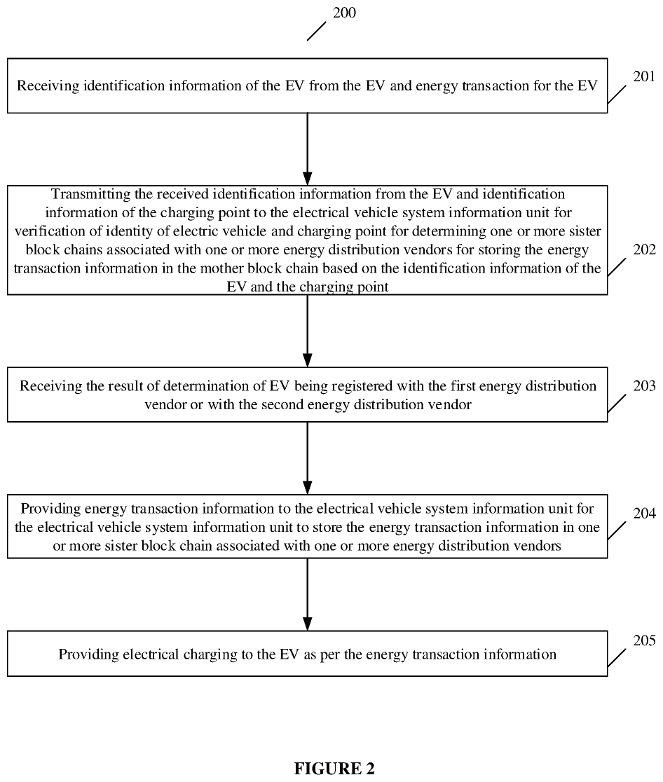

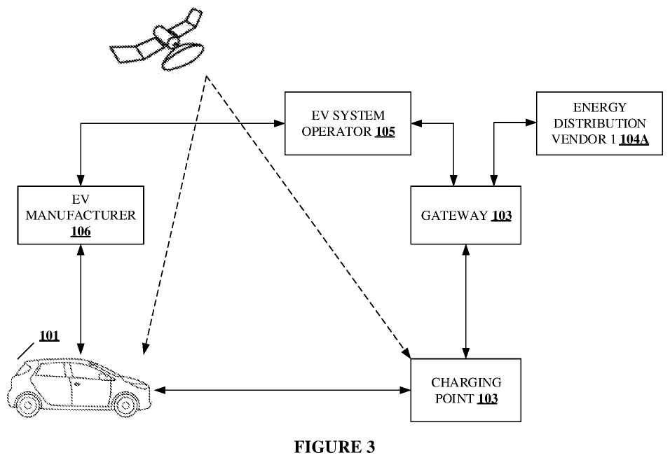

FIG. 2 illustrates an exemplary flow chart for charging the EV (101) at a charging point (103) of the EV charger (102). In an embodiment, the EV (101) may select the EV charger (102) from a plurality of EV chargers present at a particular geographical area as shown in FIG. 3. The EV (101) queries the location information regarding the EV charger (102) in a geographical area of the EV (101). In one embodiment, the query can be made to the EV manufacturer (106) and the EV manufacturer (106) forwards the query to the EVSO (105). In another embodiment, the EV (101) may query the EVSO (105). Further, the EVSO (105) will query the plurality of energy distribution vendors (104) for the location information of respective EV chargers available in the geographical area of the EV (101). The plurality of energy distribution vendors (104) shares the location information of the plurality of the EV chargers, price of charging the EV (101) at the charging point (103) of the respective EV charger (102), required charging time to charge the rechargeable batteries of the EV (101) or a waiting time for the availability of the charging point (103) at the EV charger (102) with the EVSO (105) and in turn to the EV (101) via the EV manufacturer (106) or directly to the EV (101). The EV (101) selects the charging point (103) of the EV charger (102) based on the received information. Further, the EV (101) uses navigation information for example from the satellites of the Global Positioning System (GPS) to navigate to the selected charging point (103) of the EV charger (102) for charging the EV (101).

At the step 201, the charging point (103) receives identification information of the EV (101) from the EV (101) and energy transaction information for charging the EV (101). The identification information of the EV (101) includes at least one of EV manufacturer (106) information, energy distribution unit information associated with the EV (101), EV (101) registration information, EV (101) model information, EV (101) battery capacity, compatibility of the battery with the charging point (103), and EV (101) owner information. For example, the EV manufacturer (106) information may include at least one of name and address of the EV manufacturer (106) and EV manufacturer (106) cryptographic hash, the energy distribution unit information associated with the EV (101) may include a cryptographic hash of the first energy distribution vendor (104), EV (101) registration information may include device account name, EV public key and public key for transaction with EVSO (105), EV model information may include the type of vehicle and the registration number, and EV owner information may include the device owner name and address. The Table 1 below shows an exemplary identification information the EV (101) according to the IEC61850 standard. The IEC 61850 is an international standard defining communication protocols for intelligent electronic devices at electrical substations, Part 90-8: Object model for E-mobility:

TABLE 1
Electric Vehicle identification information - IEC 61850

| | |
|---|---|
| Device account name: DEEV.NamPlate.name: | XYZ Car 1 |
| Device owner name: DEEV.NamPlate.ownName: | Shankar |
| EV details (LD0.LDEV.DevName.serNum): | Tesla IN |
| | KA53 L 4742 |
| EV public key (LD0. DEEV. NamPlate.publicKey): | 87af7157 |
| Public Key for transaction with EVSO | ac14705af1c5 |
| (LD0.GSAL.PublicKey.stVal): | |
| First Energy distributor vendor hash | B566D |
| (LD0.GSAL.EDAuthHash.stVal): | |
| EV manufacturer hash | 23776d4e |
| (LDO.GSAL.EVManHash.stVal): | |

Further, the energy transaction for the EV (101) includes at least one of the time duration for charging the EV (101) at the charging point (103) of the EV charger (102), the total cost for charging the EV (101) at the charging point (103) of the EV charger (102) and the like. In an embodiment, the identification information of the EV (101) can be obtained by the charging point (103) using for example a Radio Frequency Identification (RFID) tag mounted on the EV (101), a QR code on the EV (101), a smart card provided with the EV (101), or any such means that provide identification information. In an embodiment, the transaction information is provided by a driver/passenger of the EV (101). For example, the driver of the EV (101) can provide information such as charging the EV (101) for 10 minutes, charging the EV (101) equivalent to 500$ or charging the battery to full capacity.

At the step 202, the charging point (103) transmits the received identification information from the EV (101) and identification information of the charging point (103) to the electrical vehicle system information unit for verification of identity of the EV (101) and the charging point (103). The identification information of the charging point (103) includes EV charger (102) details, energy distribution unit information associated with the EV charger (102), battery storage capacity of EV charger (102), and EV charger (102) owner information. For example, the EV charger (102) details includes name and address of the EV charge manufacturer and model of the EV charger (102), the energy distribution unit information associated with the EV charger (102) includes the first energy distribution vendor (104) cryptographic hash, the battery storage capacity of EV charger (102) includes the total charge measured in kilo watt hour (kWh) the battery can store, and EV charger (102) owner information includes device owner name and address of the EV charger (102). Table 2 shows exemplary EV charger (102) information.

TABLE 2
EV charger Identification Information - IEC 61850

| | |
|---|---|
| Device account name: DESE.NamPlate.name: | XYZ charging station |
| Device owner name: DESE.NamPlate.ownName: | Ravi |
| EV charger ID details | XYZ CHAdeMO 1.0 |
| (LD0.LDEV.DevName.serNum): | Terra 53 |
| | CJG Ser. No. |
| | 45A68BCCA0 |
| EV charger public key (LD0. DESE. | 247e0a80 |
| NamPlate.publicKey): | |
| Public Key for transaction with in EVSO | ac14705af1c5 |
| (LD0.GSAL.PublicKey.stVal): | |
| First Energy distributor vendor hash | 95b7e7843b2f |
| (LDO.GSAL.EVEDAuthKey.stVal): | |
| Battery storage capacity of EV charger | 1 kWh |
| (LD0.PEMMTR1.StoSupWh.actVal) | |

In an embodiment the verification of identity of the EV (101) by the EVSO (105) includes comparing the cryptographic hash of the first energy distribution vendor (104), the cryptographic hash of the EV manufacturer (106) and the EV model information, and EV registration information with the data stored in the EV system information unit (112) associated with the EVSO (105). The comparison determines the registration of the EV (101) with the first energy distribution vendor (parent energy distribution vendor) or another vendor i.e. a second energy distribution vendor (104).

Further, the EVSO (105) determines one or more sister block chains (401, 402 and 403) associated with one or more energy distribution vendors (104) for storing the energy transaction information based on the identification information of the EV (101). Upon verification of the identification information of the EV (101), the energy transaction information is stored in the one or more sister block chain (401, 402 and 403) and the mother block chain (404). A blockchain is a time-stamped series of immutable record of data that is managed by cluster of computers or servers not owned by any single entity. Each record of data known as a block of data or block is secured and bound to previous block using cryptographic principles to form a chain of blocks. The block chain is a shared and immutable ledger, the information stored in the block chain is read by EVSO and plurality of energy distribution vendor. All the computers or servers involved in an energy transaction is accountable for the actions for example verification of the energy transaction performed by the computers or servers. The blockchain is a simple way of passing data from one computer or server say A to other computer or server B in an automated and safe technique. A transaction is initiated by creating a block. The block is verified by plurality of computers or servers distributed around the network. The verified block is added to a blockchain. The block chain is stored across in a database associated with the plurality of computers or servers with in EVSO and plurality of energy distribution vendor.

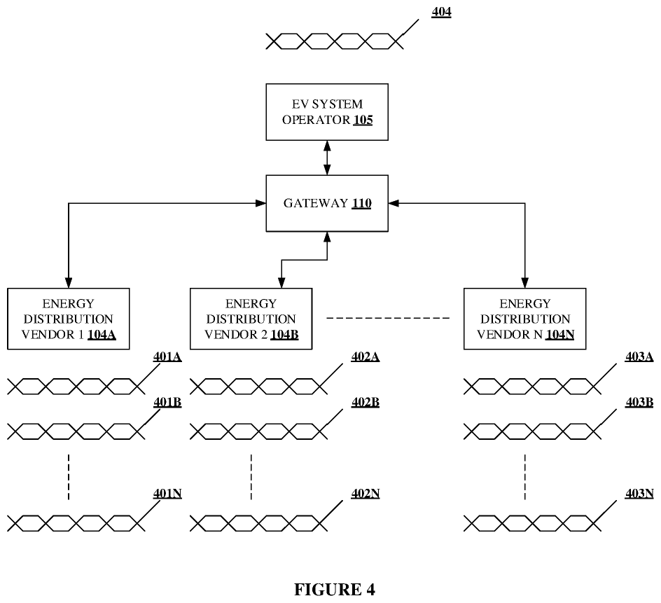

As shown in FIG. 4, an exemplary mother block chain (404) is associated with the EVSO (105) and one or more sister block chains (401, 402 and 403) are associated with the plurality of the energy distribution vendors (104). The EVSO (105) and the plurality of the energy distribution vendors (104) are communicatively connected via the gateway (110). The mother block chain (404) stores all the energy transactions associated with the plurality of the energy distribution vendors (104). Further, based on the received identification information of the EV (101) from the charging point (103) the EVSO (105) determines the one or more sister block chains (401, 402 and 403) associated with the plurality of the energy distribution vendors (104) for storing the energy transaction of the EV (101). In an embodiment, each energy distribution vendor (104) is associated with a plurality of sister block chains (401, 402 and 403). Each sister block chain (401, 402 and 403) corresponding to an energy distribution vendor (104) comprises energy transaction information of that energy distribution vendor (104) with other energy distribution vendor (104). For example, considering three vendors, namely vendor 1, vendor 2 and vendor n. The sister block chains (401, 402 and 403) associated with vendors can be:

Vendor 1 to other vendors:
EVSO.Block chain Vendor 1₁: transaction in vendor 1;
EVSO.Block chain Vendor 1₂: transaction between vendor 1 and vendor 2;
EVSO.Block chain Vendor 1₃: transaction between vendor 1 and vendor 3;
. . .
EVSO.Block chain Vendor 1ₙ: transaction between vendor 1 and vendor n;
Vendor 2 to other vendors:
EVSO.Block chain Vendor 2₂: transaction in vendor 2;
EVSO.Block chain Vendor 2₁: transaction between vendor 2 and vendor 1;
EVSO.Block chain Vendor 2₃: transaction between vendor 2 and vendor 3;
. . .
EVSO.Block chain Vendor 2ₙ: transaction between vendor 2 and vendor n;
Vendor n to other vendors:
EVSO.Block chain Vendor nₙ: transaction in vendor n;
EVSO.Block chain Vendor n₁: transaction between vendor n and vendor 1;
EVSO.Block chain Vendor n₂: transaction between vendor n and vendor 2;
. . .
EVSO.Block chain Vendor nₙ₋₁: transaction between vendor n and vendor n−1;

For example, consider the first energy distribution vendor (104) associated with the EV (101) to be vendor 2, the energy distribution vendor (104) associated with the charging point (103) of the EV charger (102) to be the vendor 2 as well and the EV (101) is to be charged by the charging point (103) of the EV charger (102). The EVSO (105) determines a sister block chain (402A) (Block chain 2₂) corresponding to vendor 2 for storing the energy transaction.

In another example, consider the first energy distribution vendor (104) associated with the EV (101) to be the vendor 2, the energy distribution vendor (104) associated with the charging point (103) of the EV charger (102) to be the vendor 1 and the EV (101) is to be charged by the charging point (103) of the EV charger (102). The EVSO (105) determines a sister block chain (402B) (Block chain 2₂) corresponding vendor 2 and a sister block chain (401B) (Block chain 2₁) corresponding vendor 2 and a sister block chain (Block chain 1₁) corresponding vendor 1 for storing the energy transaction.

At the step 203, the charging point (103) receives the result of determination of EV (101) being registered with the first energy distribution vendor (104) or with the second energy distribution vendor (104), where the EV (101) is registered with the first energy distribution vendor (104) or with the second energy distribution vendor (104). In one embodiment, the EV charger (102) is registered with the first energy distribution vendor (104). In another embodiment, the EV charger (102) is registered with the second energy distribution vendor (104). The result of determination of the EV (101) being registered is obtained from the EVSO (105) based on the verification of the identification information performed by the EVSO (105). The EVSO (105) compares the received information with the stored information. The result of determination is indicated as a “success” or a “failure” based on the comparison.

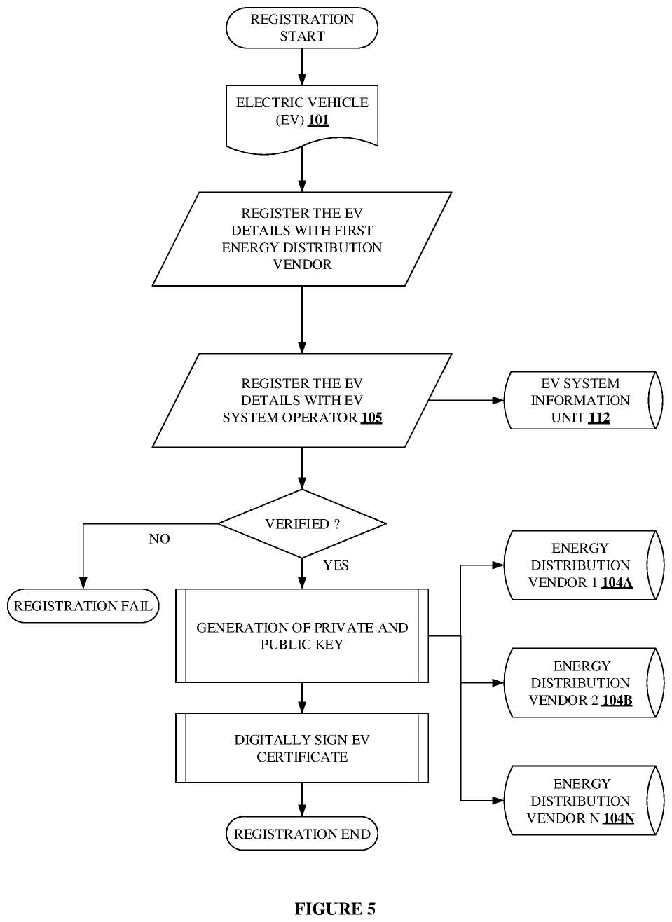

As shown in FIG. 5, the EV (101) registers itself with the first energy distribution vendor (104) among the plurality of distribution vendors and the EVSO (105). In an embodiment the registration process includes sharing the EV identification information (for example Device account name, Device owner name, EV (101) details and the like) as shown in the Table 1 below with the first energy distribution vendor (104) and EVSO (105). The EV identification information is stored in the electric vehicle system information unit (112) (e.g., database) associated with the EVSO (105). Further, the identification information of the EV (101) is verified with the EV manufacturer (106) by the EVSO (105) and EVSO (105) creates a public key for the EV (101), a private key for the EV (101) and digitally signs the EV (101) certificate using the private key of the EV (101) indicating the completion of the EV (101) registration. Furthermore, the EVSO (105) shares the public key of the EV (101) with the plurality of the energy distribution vendors (104). The plurality of energy distribution vendors (104) verifies the EV (101) based on the public key of the EV (101). The public key of the EV (101) and private key of the EV (101) is used to securely send and receive information with the EVSO (105) and the EV manufacturer (106). The information for example identification information or the energy transaction information is encrypted using the public key by the sender and sent to a receiver. The receiver decrypts the information using the private key. In an embodiment, the information is encrypted using the public key by the sender and sent to a receiver. The receiver decrypts the information using the private key.

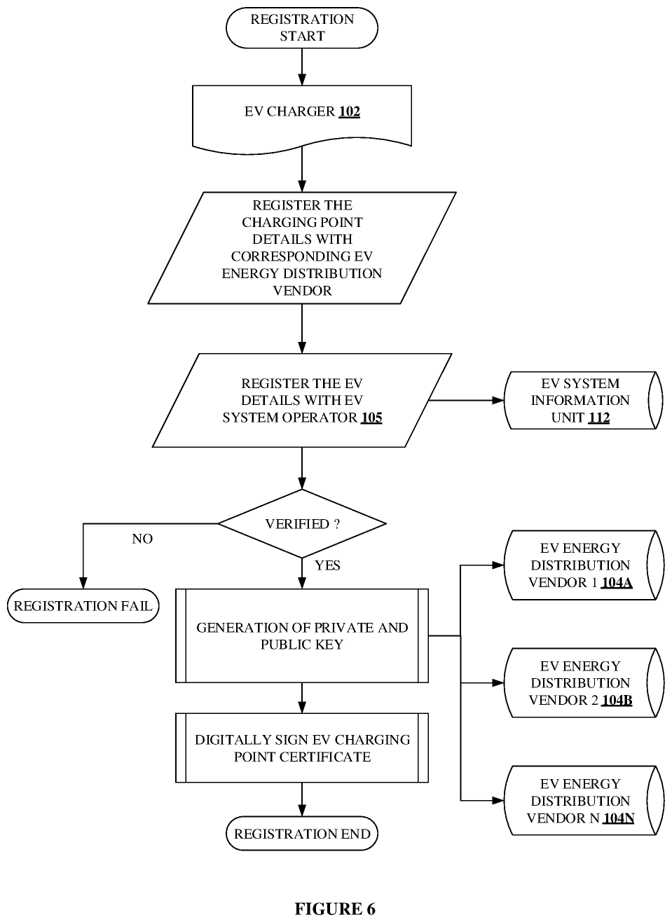

As shown in FIG. 6, the EV charger (102) registers itself with the first energy distribution vendor (104) or the second energy distribution vendor (104) among the plurality of distribution vendors and the EVSO (105). In another embodiment, the registration process includes sharing the EV charger (102) identification information (for example Device account name, Device owner name, EV charger (102) details and the like) as shown in the Table 2 with the first energy distribution vendor (104) and EVSO (105). The EV charger (102) identification information is stored in the electric vehicle system information unit (112) associated with the EVSO (105) and the vendor information unit (111) associated with the first energy distribution vendor (104) or the second energy distribution vendor (104). Further, the identification information of the EV charger (102) is verified with the EV charger (102) manufacturer by the EVSO (105) and EVSO (105) creates a public key for the EV charger (102), a private key for the EV charger (102) and digitally signs the EV charger (102) certificate using the private key of the EV charger (102) indicating the completion of the EV charger registration. Furthermore, the EVSO (105) shares the public key of the EV charger (101) with the plurality of the energy distribution vendors (104). The plurality of energy distribution vendors (104) verifies the identification information of the EV (101) charger and the digitally signed EV (101) charger certificate based on the public key of the EV (101). The public key of the EV (101) and private key of the EV (101) is used to securely send and receive information with the EVSO (105) and the EV manufacturer (106). The information for example identification information or the energy transaction information is encrypted using the public key by the sender and sent to a receiver. The receiver decrypts the information using the private key. In an embodiment, the information is encrypted using the public key by the sender and sent to a receiver. The receiver decrypts the information using the private key. Further, the public and private key is used to encrypt and decrypt the messages between the charging point (103) and the EVSO (105).

At the step 204, the charging point (103) provides the energy transaction information to the EV system information unit (112) to store the energy transaction information in one or more sister block chain (401, 402 and 403) associated with one or more energy distribution vendors (104). The energy transaction information is stored in at least one of a sister block chain (401, 402 and 403) associated with the first energy distribution vendor (104) when the charging is being performed by the first energy distribution vendor (104) and the sister block chain (401, 402 and 403) associated with the first energy distribution vendor (104) and the second energy distribution vendor (104), when the charging is being performed by the second energy distribution vendor (104). In an embodiment, each energy transaction information is time stamped using “.t” attribute of the IEC 61850 protocol. The energy transaction information from the plurality of the energy distribution vendors (104) are stored in one block of a blockchain within the predefined time period. Each block of the block chain is joined to the previous block of the block chain by a cryptographic hash, a linked list and a dedicated block chain software.

Further, the energy transaction information comprises at least one of details of the EV (101), details of the EV charging point (103) of the EV charger (102), details of the first or second energy distribution vendor (104), details of manufacturer of the EV (101), duration of charging the EV (101) at the charging point (103) of the EV charger (102), details of unit cost of energy transfer, details of total cost of charging the EV (101) at the charging point (103) of the EV charger (102). The EV charger (102) calculates charging energy information over the charging time period for the EV (101) using the equations given below.

$$Total charging Energy = \pm {\sum }_{t = 0}^{n} Pn * Δ t \qquad ( 1 )$$

where Pn is energy measured at “n^{th}” instant

Δt is a time between measurement iteration

n=total number of iterations within charging period

$$Total charging cost = {\sum }_{t = 0}^{n} Pn * Δ t * Cn + {\sum }_{t = 0}^{n} EVn * t \qquad ( 2 )$$

where Cn is cost of energy at “n^{th}” instant
EVn is a profit margin of the EV (101) charging host, first energy distribution vendor (104) of the EV charger (102), as defined by first energy distribution vendor (104) within rules prescribed by EVSO (105).

The energy transaction information is recorded according IEC 61850 protocol. An example of the energy transaction information is shown in the Table 3 below:

TABLE 3

| | | | Access to data |
|---|---|---|---|
| Energy transaction details | Value/Hash value | Access rights | miners |
| Device account name: | Tesla Car 1 | Read by EVSO, | No read/write |
| DEEV.NamPlate.name: | | plurality of energy | access |
| | | distribution vendor | |
| Device owner name: | Shankar | Read by EVSO, | No read/write |
| DEEV.NamPlate.ownName: | | plurality of energy | access |
| | | distribution vendor | |
| EV details | Tesla IN KA53 L | Read by EVSO, | No read/write |
| (LD0.LDEV.DevName.serNum): | 4742 | plurality of energy | access |
| | | distribution vendor | |
| EV public key (LD0. DEEV. | 87af7157 | Read by EVSO, | Read access |
| NamPlate.publicKey): | | plurality of energy | |
| | | distribution vendor | |
| | | in EV charging | |
| | | ecosystem | |
| Public Key for transaction with | ac14705af1c5 | Read by EVSO, | Read access |
| EVSO (LD0.GSAL.PublicKey): | | plurality of energy | |
| | | distribution vendor | |
| First Energy distributor vendor hash | B566D | Read by EVSO and | Read access |
| (LDO.GSAL.EDAuthHash.stVal): | | plurality of energy | |
| | | distribution vendor | |
| EV manufacturer hash | 23776d4e | Read by EVSO and | No Read access |
| (LDO.GSAL.EVManHash.stVal) | | plurality of energy | |
| | | distribution vendor | |
| Device account name: | XYZ charging station | Read by EVSO, | No read/write |
| DESE.NamPlate.name: | | plurality of energy | access |
| | | distribution vendor | |
| Device owner name: | Ravi | Read by EVSO, | No read/write |
| DESE.NamPlate.ownName: | | plurality of energy | access |
| | | distribution vendor | |
| EV charger details | XYZ CHAdeMO 1.0 | Read by EVSO, | No read/write |
| (LD0.LDEV.DevName.serNum): | Terra 53 CJG Ser. No. | plurality of energy | access |
| | 45A68BCCA0 | distribution vendor | |
| EV charger public key | 247e0a80 | Read by everyone | Read access |
| (LD0. DESE. NamPlate.publicKey): | | in EV ecosystem | |
| EV charger Public Key for | ac14705af1c5 | Read by EVSO and | Read access |
| transaction with EVSO | | plurality of energy | |
| (LD0.GSAL.PublicKey.stVal): | | distribution vendor | |
| | | Others no read | |
| | | access | |
| First Energy distributor vendor | 95b7e7843b2f | Read by EVSO and | Read access |
| (LDO.GSAL.EVEDAuthKey.stVal): | | plurality of energy | |
| | | distribution vendor | |
| | | Others no read | |
| | | access | |
| Battery storage capacity of the | 1 kWh | Read by EVSO and | No read access |
| EV charger | | plurality of energy | |
| (LD0.PEMMTR1.StoSupWh.actVal) | | distribution vendor | |
| | | and EV charging | |
| | | host, Write by EV | |
| | | charging host | |
| | | Others no read | |
| | | access | |
| Time stamp of total energy | 19-Sept-17:10:20AM | Read by EVSO and | Read access |
| consumption during charging | (Start) | plurality of energy | |
| Energy: measurement using | 19-Sept-17:10:40AM | distribution vendor | |
| metering logical node | (End) | and EV charging | |
| LD0.PEMMTR1.SupWh.t(start) | | host, Write by EV | |
| LD0.PEMMTR1.SupWh.t(end) | | charging host | |
| | | Others no read | |
| | | access | |
| Unit cost of Energy defined by DSO | 1INR/kWh | Read by public | Read access |
| LD0.DSODSCH1.CostSupWh.actVal | | | |
| Total cost of consumption by | 1000 INR | Write by EVSO | Read access |
| EV: Energy: measurement | | and plurality of | |
| DER energy and/or ancillary | | energy distribution | |
| services schedule logical node | | vendor Read by | |
| LD0.EVDSCH1.CostSupWh.actVal | | EV, EV charging | |
| | | point Others no | |
| | | read access | |
| Total profit earned by EV | 100 INR | Write by EVSO | Read access |
| charging host | | and plurality of | |
| DER energy and/or ancillary | | energy distribution | |
| services schedule logical node | | vendor, Read be | |
| LD0.EVHODSCH1.CostSupWh.actVal | | EV charging host | |
| Total profit earned by parent EV | 10 INR | Write by EVSO | Read access |
| charging host: | | Read be EV | |
| DER energy and/or ancillary | | charging host | |
| services schedule logical node | | parent company | |
| LD0.EVCHDSCH.CostSupWh.actVal | | plurality of energy | |
| | | distribution vendor | |
| | | Others no access | |
| Total profit earned by EV | 10 INR | Write by EVSO | Read access |
| parent company: | | Read EV energy | |
| DER energy and/or ancillary | | parent company or | |
| services schedule logical node | | EV energy | |
| LD0.EVPCDSCH1.CostSupWh.actVal | | distributor | |
| | | company | |
| Total profit earned by EVSO | 5INR | Read and write by | No read/write |
| Internal EVSO data | | EVSO Others no | access |
| LD0.EVPCDSCH1.ProfSupWh.actVal | | read access | |
| LD0.EVPCDSCH1.TrdRdy.stVal | True | Read by EVSO, | Write/read access |
| Transaction Read | | plurality of energy | |
| | | distribution vendor | |
| Hashing of each block | 8DE98019CDD599C7 | Read/write by | Read/write by |
| LD0.EVPCDSCH1.BlkHash.stVal | 5DFB96CB0004922B | Software | Software |
| | 0AF2074D277882FF0 | | |
| | A7B2BD3DF413F1D | | |

The energy transaction shown in the Table 3 includes a plurality of attributes (for example EV (101) details) associated with the charging of the EV (101) at the charging point (103) of the EV charger (102) in the column 1 of the table above. Every attribute among the plurality of attributes has a corresponding value as shown in the column 2 of the Table 3. Further, the column 3 of the Table 3 indicates the access rights of the attributes in the energy transaction information. The access rights indicate read and write permissions to at least one of the EVSO (105), first energy distribution vendor (104) and second energy distribution vendor (104). The column 4 indicates the access rights to the data miners (701). In an embodiment, the data miners (701) are a computer or a server for verifying the total energy expenditure with the total energy received.

At the step 205, the charging point (103) provides the electrical charging to the EV (101) as per the energy transaction information as detailed in the step 204.

In an embodiment, current and voltage samples values of the EV (101) charging is recorded using IEC 61850 9-2 protocol and transmitted to the first distribution unit for performing remote diagnostic check of the EV (101). The current and voltage sample values are stored in time series in the vendor information unit (111) associated with the first distribution vendor. In an exemplary embodiment, the current and voltage sample values are analyzed using moving window method. The moving window method includes determining a Discrete Fourier Transform (DFT) and a wavelet transform of the current and the voltage sample values. Based on the DFT and wavelet transform the frequency and time series a probabilistic failure information of the converter in EV charger can be identified. An example of the current and voltage sample values recorded using IEC 61850 9-2 protocol is shown below.

TABLE 4

| | Time-1 | Time-2 | . . . | Time-n |
|---|---|---|---|---|
| Device ID | LD0.LDEV.DevName.serNum | LD0.LDEV.DevName.serNum | . . . | LD0.LDEV.DevName.serNum |
| Current | LD0.DESE.A.instMag-1 | LD0.DESE.A.instMag-2 | . . . | LD0.DESE.A.instMag-n |
| Sample | | | | |
| values | | | | |
| Voltage | LD0.DESE.PhV.instMag-1 | LD0.DESE.PhV.instMag-2 | . . . | LD0.DESE.PhV.instMag-n |
| Sample | | | | |
| values | | | | |
| Time | LD0.DESE.A.t-1 | LD0.DESE.A.t-2 | . . . | LD0.DESE.A.t-n |
| stamp | | | | |

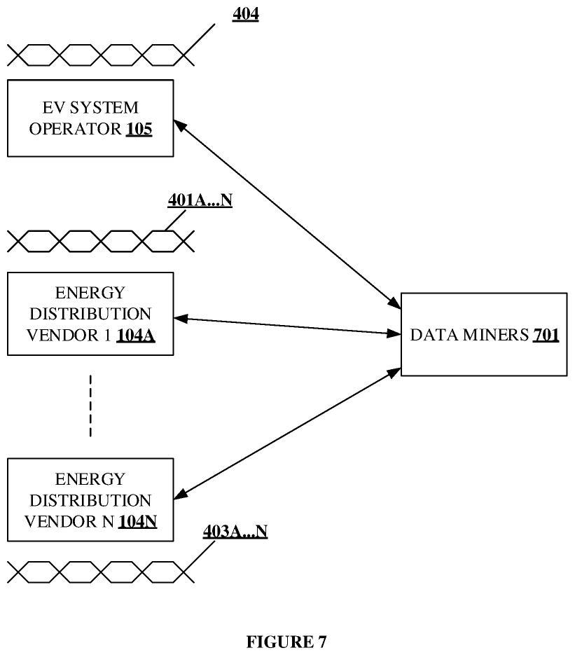

In an embodiment, the data miners (701) are provided with an access to read all the energy transaction information stored in the mother block chain (404) and one or more sister block chain (401, 402 and 403) as shown in FIG. 7. Every transaction stored in the mother block chain (404) and the one or more sister block chains (401, 402 and 403) are verified based on the public key of the EV (101), the public key of the EV charger (102) in energy transaction information and the public key of EVSO (105). The energy consumed by EV (101) for charging the rechargeable batteries of the EV (101) must be approximately equal to the energy supplied by the plurality of EV energy distribution vendors (104) to the EV (101) excluding the tolerance of energy losses. The verification of the energy consumed by the EV (101) and the energy supplied by the plurality of the EV energy distribution vendors (104) is verified using the equation given below.

$${\sum }_{i = 1}^{n} {E}_{EV ( i )} ≅ {\sum }_{k = 1}^{m} {E}_{Ev charingPoint ( k )} \qquad ( 3 )$$

In an embodiment, if the demand in an energy distribution vendor (104) among the plurality of the energy distribution vendors (104) is greater than a predefined threshold value then the DSO (107) could issue a circuit breaker command to the EVSO (105). Further, the EVSO (105) could limit the EV (101) charging power or switch off the EV (101) charging remotely of the energy distribution vendors (104) among the plurality of the energy distribution vendors (104) to prevent a grid (108) collapse.

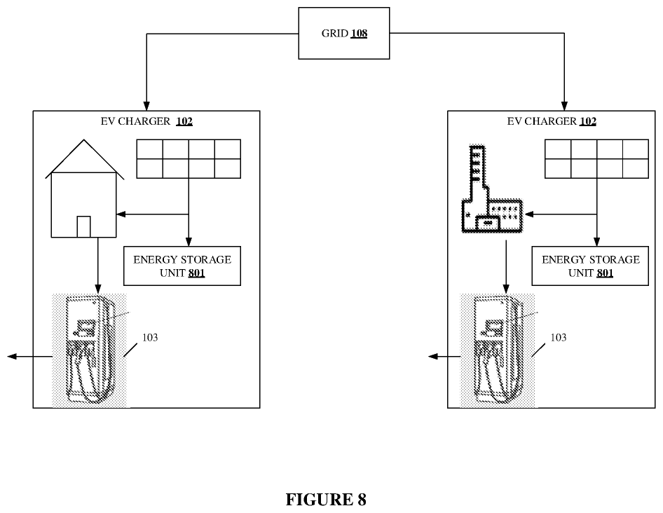

In an embodiment, a house or a commercial complex can act as an EV (101) charging including a charging point (103) as shown in FIG. 8. The charging point (103) has an energy storage unit (801) for storing energy generated during excessive generation by the grid (108). Further, the energy storage unit (801) can store the energy generated by the renewable sources of energy for example solar energy as shown in FIG. 8. The EVSO (105) monitored by the DSO (107) sets an energy charge pricing for the EV (101) charging at the home or the commercial complex. Further, the energy transaction is stored in the mother block chain (404) and the sister block chain (401, 402 and 403) associated with the first energy distribution vendor (104) of the EV (101).

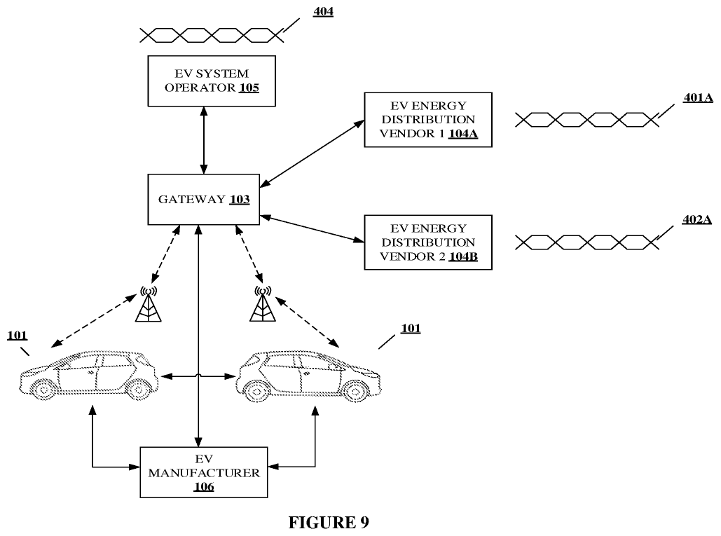

In an embodiment, if a first EV (101) and a second EV (101) have a compatible power socket then a first EV (101) can charge the second EV (101) or vice versa as shown in FIG. 9. The EV (101) providing the charge acts as the charging point (103). Further, the charging of the EV (101) is performed after the EVSO (105) verifies the identification information of the first EV (101) and the identification information of the second EV (101). The identification information of the first EV (101) and the second EV (101) is sent to the EVSO (105) via the gateway (110) through the cellular network. The energy transaction is stored in the mother block chain (404) associated with the EVSO (105), and the sister block chain (401, 402 and 403) associated with the corresponding first energy distribution vendor (104) of the first EV (101) (for example vendor 1) and the first energy distribution vendor (104) of the second EV (101) (for example vendor 2) as shown in the FIG. 9.

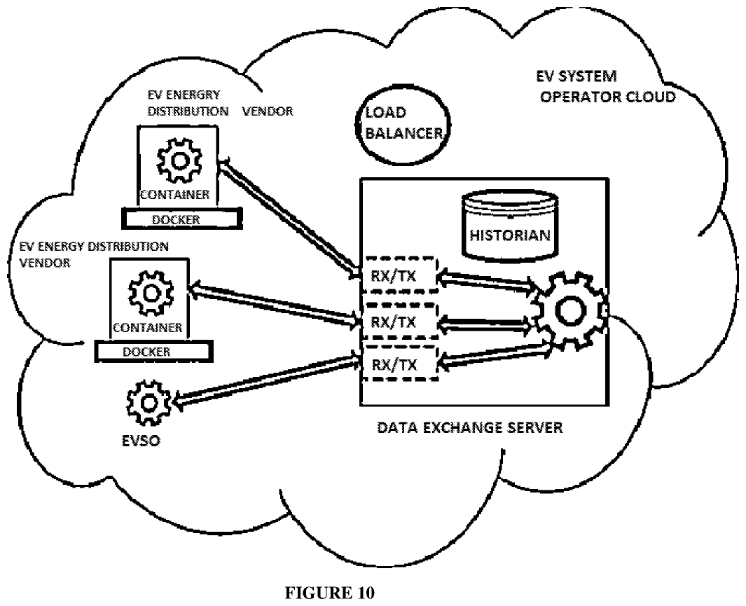

In an embodiment, the block chain associated with an EV energy distribution vendor (104) among the plurality of energy distribution vendors (104) are stored in a dedicated application on a host cloud using containers as shown in FIG. 10. A container is a standard unit of software that packages up code and all its dependencies, so the dedicated application runs quickly and reliably regardless of the environment. The container program runs on Dockers/Kubernetes which enables executions of containers in any host machine or virtual machine or cloud. A Docker container image is a lightweight, standalone, executable package of software that includes everything needed to run an application for example a code, runtime, system tools, system libraries and settings. The public key of the energy distribution vendor (104) is used to authenticate the containers. Further, a Data exchange server (DES) associated with the EVSO (105) stores the energy transactions of the mother block chain (404) in a historian file system (for example HADOOP). The DES provides EVSO (105), data miners (701) and the plurality of energy distribution vendors (104) the required data for based on the access rights of charging the EV (101) at the charging point (103) of the EV charger (102).

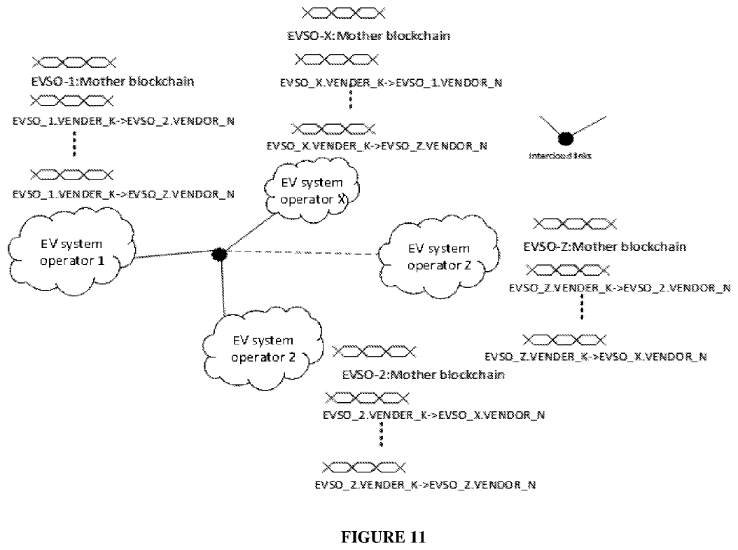

In an embodiment, one or more EVSO can associate with each other to co-ordinate and manage the charging of the EV at a charging point of the EV charger. The one or more EVSO involved in the association forms a consortium of EVSO as shown in FIG. 11. Each EVSO in the consortium of EVSO performs a handshake using an intercloud operation. The one or more EVSO in the CONSORTIUM of EVSO creates a sister block chain corresponding to the vendor 1 governed by the EVSO 1 and vendor 2 governed by the EVSO 2 for storing the energy transaction between the vendor 1 of the EVSO 1 and a vendor 2 of the EVSO 2. For example, the energy transactions within plurality of vendors governed by the EVSO_Z is stored in a mother block chain of the EVSO_Z (CONSORTIUM.EVSO_Z as shown in Table-5). Further, in another example, consider an energy transaction between a vendor K governed by EVSO_X and a vendor N governed by EVSO_Z. The energy transaction is stored in a sister block chain (CONSORTIUM. EVSO_X.VENDER_K->EVSO_Z.VENDER_N as shown in Table-5), a mother block chain of the EVSO_X (CONSORTIUM.EVSO_X as shown in Table-5), and a mother block of the EVSO_Z (CONSORTIUM.EVSO_Z as shown in Table-5) as shown in FIG. 11. The Table 5 indicates exemplary mother and sister block chain associated with one or more EVSO in the consortium of EVSO.

TABLE 5

| Number | Block chain | Comments |
|---|---|---|
| EVSO 1 | CONSORTIUM.EVSO_1:Tag:MotherBlockChain | Mother block chain |
| | | within EVSO 1: |
| EVSO 1 −>2 | CONSORTIUM.EVSO_1.VENDER_K−> | transaction between |
| | EVSO_2.VENDOR_N:Tag:SisterBlockChain | vendor K who is |
| | | governed by EVSO_1 |
| | | and Vendor N who is |
| | | governed by EVSO_2 |
| EVSO 2 | CONSORTIUM.EVSO_2:Tag:MotherBlockChain | Mother block chain |
| | | within EVSO 2: |
| EVSO 2 −>1 | CONSORTIUM.EVSO_2.VENDER_N−> | transaction between |
| | EVSO_1.VENDOR_K:Tag:SisterBlockChain | vendor N who is |
| | | governed by EVSO_2 |
| | | and Vendor K who is |
| | | governed by EVSO_1 |
| | . . . | |
| EVSO Z | CONSORTIUM.EVSO_Z:Tag:MotherBlockChain | Mother block chain |
| | | within EVSO Z: |
| EVSO Z −>X | CONSORTIUM.EVSO_Z.VENDER_K−> | transaction between |
| | EVSO_X.VENDOR_N:Tag:SisterBlockChain | vendor K who is |
| | | governed by EVSO_Z |
| | | and Vendor N who is |
| | | governed by EVSO_X |
| EVSO X | CONSORTIUM.EVSO_X:Tag:MotherBlockChain | Mother block chain |
| | | within EVSO X: |
| EVSO X −>Z | CONSORTIUM.EVSO_X.VENDER_N−> | transaction between |
| | EVSO_Z.VENDOR_K:Tag:SisterBlockChain | vendor N who is |
| | | governed by EVSO_X |
| | | and Vendor K who is |
| | | governed by EVSO_Z |

In an embodiment, a single authentication key is used to authenticate and charge the EV (101) from a plurality of energy distribution vendors (104), a house, or a commercial complex. The EV (101) can locate the charging point (103) from a plurality of charging points for charging the EV (101) based on the distance to the plurality of charging points, unit energy cost for charging the EV (101) and availability of the plurality of charging points. The energy transaction is stored in mother and sister block chain (401, 402 and 403) and the total energy received and consumed is verified by the data miners (701). The EVSO (105) based on the guidelines of the DSO (107) monitors and manages the energy distribution to the plurality of energy distribution vendors (104).

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### REFERRAL NUMERALS

101—Electric Vehicle
102—EV Charger
103—Charging point
104—energy distribution vendor
105—EV system operator
106—EV manufacturer
107—Distribution System Operator
108—Grid
109—Communication Network
110—Gateway
111—Vendor Information Unit
112—EV system information unit
401, 402 and 403—Sister blockchain of vendor 1
404—Mother blockchain
701—Data Miners
801—Energy storage unit

1. A method for charging an Electric Vehicle from a charging point of an EV charger, wherein identification information of the EV is stored in a vendor information unit associated with a first energy distribution vendor or a second energy distribution vendor among plurality of energy distribution vendors and with an electric vehicle system information unit associated with an electric vehicle system operator,
wherein the charging point of the EV charger is communicably connected to the electrical vehicle system information unit,
identification information of the charging point of the EV charger is stored in the vendor information unit associated with the first energy distribution vendor, and identification information of the plurality of energy distribution vendors are stored in the electric vehicle system information unit, and a plurality of information relating to energy transactions performed by the plurality of energy distribution vendors is stored in a mother block chain associated with the electric vehicle system information unit of the EVSO, the method comprises, the charging point:
receiving identification information of the EV from the EV and energy transaction for the EV;
transmitting the received identification information from the EV and identification information of the charging point to the electrical vehicle system information unit for verification of identity of electric vehicle and identity of charging point for determining one or more sister block chains associated with one or more energy distribution vendors from the plurality of energy distribution vendors for storing the energy transaction information in the mother block chain based on the identification information of the EV and charging point;
receiving the result of determination of EV being registered with the first energy distribution vendor or with the second energy distribution vendor wherein the EV is registered with the first energy distribution vendor or with the second energy distribution vendor;
providing energy transaction information to the electrical vehicle system information unit for the electrical vehicle system information unit to store the energy transaction information in one or more sister block chain associated with one or more energy distribution vendors based on determination of EV being registered with the first energy distribution vendor or with the second energy distribution vendor; and
providing electrical charging to the EV as per the energy transaction information.

2. The method as claimed in claim 1, wherein the storing of the energy transaction information in the one or more sister block chain comprises storing the energy transaction information in at least one of:
a sister block chain associated with the first energy distribution vendor when the charging is being performed by the first energy distribution vendor, or,
the sister block chain associated with the first energy distribution vendor and the second energy distribution vendor, when the charging is being performed by the second energy distribution vendor.

3. The method as claimed in claim 1, wherein the identification information of the EV comprises at least one of an EV manufacturer information associated with the EV, an EV registration information, an EV model information, or an EV owner information.

4. The method as claimed in claim 1, wherein the energy transaction information comprises at least one of an identification information of the EV, an identification information of the EV charging point of the EV charger, an identification information of the first or second energy distribution vendor, a duration of charging the EV at the charging point of the EV charger, a unit cost of energy transfer, or a total cost of charging the EV at the charging point of the EV charger.

5. The method as claimed in claim 1, wherein the energy transaction information is recorded according IEC 61850 protocol.

6. The method as claimed in claim 1, wherein current and voltage samples values of the EV charging is recorded using IEC 61850 9-2 protocol and transmitted to the first energy distribution vendor for performing remote diagnostic check of the EV.

7. The method as claimed in claim 1, wherein the energy transaction information stored in the mother block chain is used by data miners to verify total energy consumed by the EV during charging.

8. A charging point for charging an EV charger of an Electric Vehicle, wherein identification information of the EV is stored in a vendor information unit associated with a first energy distribution vendor or a second energy distribution vendor among plurality of energy distribution vendors and with an electric vehicle system information unit associated with an electric vehicle system operator,
wherein the charging point of the EV charger is communicably connected to the electrical vehicle system information unit,
identification information of the charging point of the EV charger is stored in the vendor information unit associated with the first energy distribution vendor, and identification information of the plurality of energy distribution vendors are stored in the electric vehicle system information unit, and a plurality of information relating to energy transactions performed by the plurality of energy distribution vendors is stored in a mother block chain associated with the electric vehicle system information unit of the EVSO, the charging point comprises:
a processor; and
a memory communicatively coupled to the processor, wherein the memory stores the processor instructions, which, on execution, causes the processor to:
receive identification information of the EV from the EV and energy transaction for the EV;
transmit the received identification information from the EV and identification information of the charging point to the electrical vehicle system information unit for verification of identity of electric vehicle and for determining one or more sister block chains associated with one or more energy distribution vendors from the plurality of energy distribution vendors for storing an energy transaction information and for storing an energy transaction information and for storing the energy transaction information in the mother block chain based on the identification information of the EV;
receive the result of determination of EV being registered with the first energy distribution vendor or with the second energy distribution vendor wherein the EV is registered with the first energy distribution vendor or with the second energy distribution vendor;
provide energy transaction information to the electrical vehicle system information unit for the electrical vehicle system information unit to store the energy transaction information in one or more sister block chain associated with one or more energy distribution vendors based on determination of EV being registered with the first energy distribution vendor or with the second energy distribution vendor; and
provide electrical charging to the EV as per the energy transaction information.

9. The charging point as claimed in claim 8, wherein the processor is configured to store the energy transaction information in the one or more sister block chain comprises storing the energy transaction information in at least one of:
a sister block chain associated with the first energy distribution vendor when the charging is being performed by the first energy distribution vendor, and
the sister block chain associated with the first energy distribution vendor and the second energy distribution vendor, when the charging is being performed by the second energy distribution vendor.
